(19) United States
(12) Patent Application Publication
(10) Pub. No.: US 2025/0324235 A1
(43) Pub. Date: Oct. 16, 2025

(54) SYSTEM AND METHOD FOR MANAGEMENT OF ENHANCED EQUIPMENT IDENTIFIERS

(71) Applicant: Verizon Patent and Licensing Inc., Basking Ridge, NJ (US)

(72) Inventors: Qi Lu, Round Rock, TX (US); Manuel Enrique Caceres, Basking Ridge, NJ (US); Mun Wei Low, Irving, TX (US); Warren Hojilla Uy, Randolph, NJ (US)

(21) Appl. No.: 18/634,078

(22) Filed: Apr. 12, 2024

(51) Int. Cl. H04W 8/18; H04W 12/03

(52) U.S. Cl. CPC H04W 8/183; H04W 12/03

(57) ABSTRACT

A device may include a processor. The processor may be configured to: detect either provisioning or deprovisioning a User Equipment device (UE) with a carrier profile; obtain a first identifier that identifies the UE and a second identifier that identifies the carrier profile; and generate a third identifier based on the first identifier and the second identifier, wherein the third identifier associates the first identifier and the second identifier. The processor may be further configured to either store the third identifier via a network device included in the network; or revoke the third identifier.

### BACKGROUND INFORMATION

To satisfy the needs and demands of users of mobile communication devices, providers of wireless communication services continue to improve and expand their networks. One aspect of such improvements includes identifying subscribers. Each mobile device that attaches to a cellular network includes a type of Universal Integrated Circuit Card (UICC), such as an embedded UICC (eUICC). A UICC may be implemented to support various types of Subscriber Identity Modules (SIMs) (e.g., an embedded SIM (eSIM)). As the name implies, a SIM may store information associated with a user who is subscribed to the cellular network to receive various communication services (e.g., an Internet service).

### BRIEF DESCRIPTION OF THE DRAWINGS

FIG. 1 illustrate concepts described herein.

FIG. 2 illustrates an exemplary network environment in which systems and methods described herein may be implemented.

FIG. 3 depicts example components of a User Equipment device (UE) according to an implementation.

FIG. 4 illustrates a portion of a network environment, according to an implementation.

FIG. 5 depicts example components of an example Enhanced Equipment Identifier (E2ID) database (DB), according to an implementation.

FIG. 6 is a flow diagram of an exemplary process for managing E2IDs in response to provisioning carrier profiles, according to an implementation.

FIG. 7 a messaging diagram that is associated with a process for managing E2IDs in response to provisioning carrier profiles, according to an implementation.

FIG. 8 is a flow diagram of an exemplary process for managing E2IDs in response to deprovisioning carrier profiles, according to an implementation.

FIG. 9 a messaging diagram that is associated with a process for managing E2IDs in response to deprovisioning carrier profiles, according to an implementation.

FIG. 10 depicts exemplary functional components of a network device according to an implementation.

### DETAILED DESCRIPTION

The following detailed description refers to the accompanying drawings. The same reference numbers in different drawings may identify the same or similar elements.

As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID). The entity which operates the provider network may be referred to as a Mobile Network Operator (MNO) or a carrier.

Systems and methods described herein relate to management of Enhanced embedded Universal Integrated Circuit Card Identifiers or Enhanced Equipment Identifiers (E2IDs). Some User Equipment devices (UEs) (e.g., cellular telephones) may include only a single removable Integrated Circuit Card (ICC) or a Universal ICC (UICC) (broadly referred to as a “SIM card”) for storing a carrier profile (e.g., data which the carrier provisions to the UE and which the UE uses to authenticate at and to receive services from the provider network). For such UEs, it may be easy for MNOs to manage carrier profiles. For example, to activate a new phone, the user merely has to transfer the ICC from the previous phone to the new phone. In contrast, many newer UE models include one or more embedded UICCs (eUICCs) that replace removable ICCs. Such UEs may host multiple carrier profiles associated with subscriptions at one or more carriers; and each user subscription may be associated with multiple UEs and, hence, multiple carrier profiles. This renders managing carrier profiles more complex for MNOs. The systems and methods described herein implement Enhanced embedded UICCID or Enhanced Equipment Identifier (E2ID) to facilitate the management of carrier profiles. As explained below, an E2ID may specify an association between an eUICC and a carrier profile.

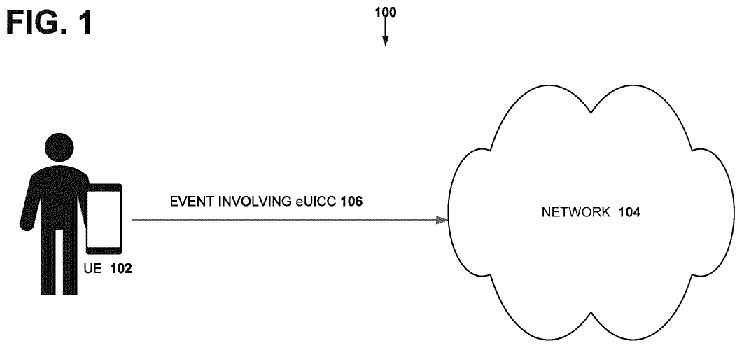

FIG. 1 illustrates the concepts described herein. As shown, a user with a UE 102 may communicate 106 an event that involves the eUICC in UE 102 and a carrier profile. Examples of such an event may include contacting a call center at a provider network 104 to initiate the activation of UE 102 or to add another line to/for UE 102; contacting provider network 104 via another network (e.g., a wireless local area network (WLAN) and/or the Internet) to initiate the activation; contacting provider network 104 to terminate an account that is associated with UE 102; retiring an old UE 102 and switching to a new UE 102; associating UE 102 with a subscription at another cellular network managed by the same MNO, etc. As a result of the communication 106, provider network 104 may provision, deprovision, or update a carrier profile at the eUICC of UE 102.

In FIG. 1, a system for managing E2ID may include one or more components of UE 102 and provider network 104. When the system detects a new pair of an eUICC identifier (EID) and a carrier profile (e.g., detect a new pair of EID and ID of a carrier profile), the system may generate a new E2ID for the pair/combination. Conversely, if a carrier profile is deprovisioned at UE 102, the system may revoke the E2ID (e.g., delete the E2ID or change the state of E2ID). If the E2ID has not been revoked, the system may use the E2ID for tracking carrier profiles (e.g., obtain the ID associated with the eUICC and use the ID for updating the carrier profile at the eUICC of UE 102) in an efficient and convenient manner.

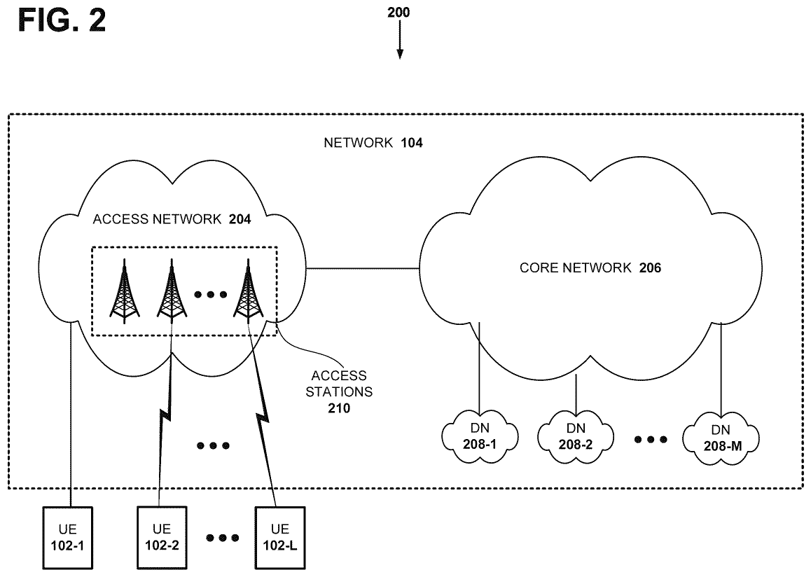

FIG. 2 illustrates an exemplary network environment 200 in which the systems and methods may be implemented. As shown, environment 200 may include UEs 102-1 through 102-L (collectively referred to as UEs 102 and generically referred to as UE 102), an access network 204, a core network 206, and data networks (DNs) 208-1 through 208-M (collectively referred to as data networks 208 and generically referred to as data network 208). Access network 204, core network 206, and data networks 208 may be part of provider network 104.

UEs 102 may include wireless communication devices capable of 5G New Radio (NR) communication, Fourth Generation (4G) (e.g., Long-Term Evolution (LTE)) communication, wireless local area network (WLAN) communication, Bluetooth® communication, etc. To enable UEs 102 to communicate with 4G or 5G cellular networks, UEs 102 may include eUICCs that store carrier profiles. Examples of UE 102 include: a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor; a Fixed Wireless Access (FWA) device; a Customer Premises Equipment (CPE) device, with or without WI-FI capabilities; and an Internet-of-Things (IoT) device. In some implementations, UE 102 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

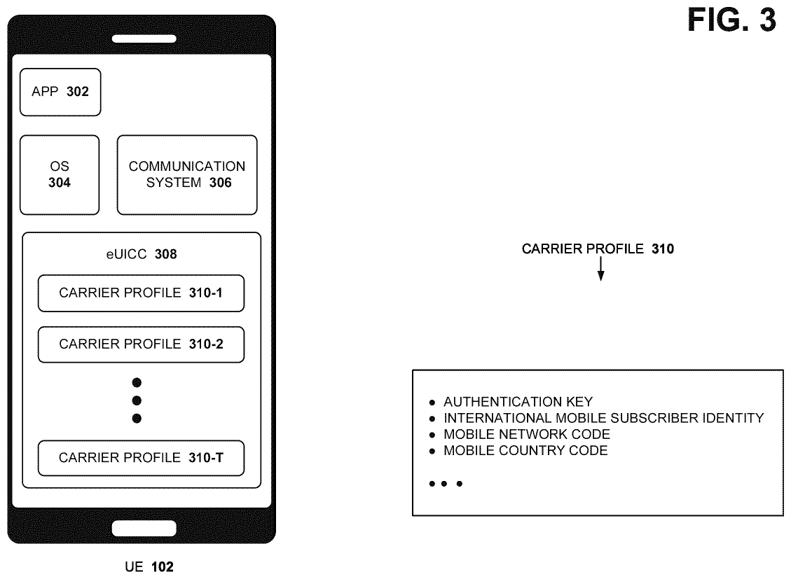

UEs 102 may include one or more components that are part of the system for managing E2IDs. For example, in one implementation, UE 102 may include an application for generating and sending E2IDs to network 104 and for revoking E2IDs from network 104. UE 102 may generate a new E2ID when the application detects a new carrier profile provisioned onto the eUICC of UE 102 and revoke a previously generated E2ID when the application detects removal of the carrier profile. In a different implementation, E2IDs may be generated by and revoked by network 104. UE 102 is described in greater detail with reference to FIG. 3.

Access network 204 may allow UE 102 to access core network 206. To do so, access network 204 may establish and maintain, with participation from UE 102, an over-the-air channel with UE 102; and maintain backhaul channels with core network 206. Access network 204 may relay information through such channels, from UEs 102 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., eNB, gNB, etc.) that comprises one or more radio frequency (RF) transceivers. In some implementations, access station 210 may be part of an evolved Universal Mobile Telecommunications Service (UMTS) Terrestrial Radio Access Network (eUTRAN).

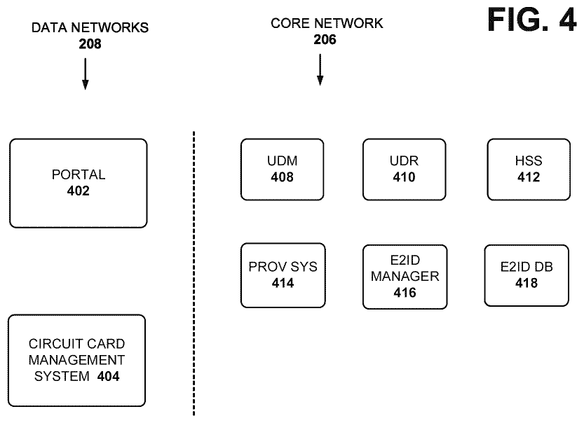

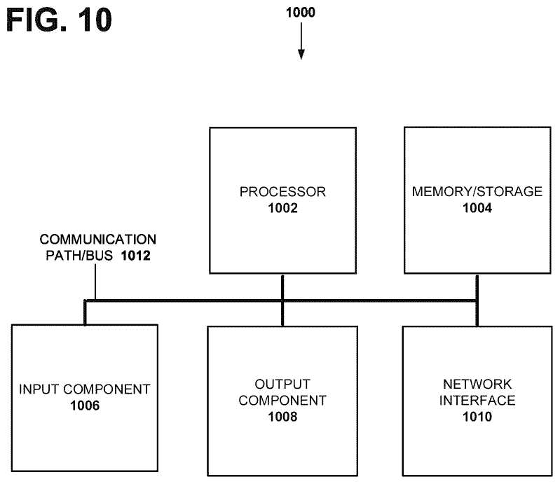

Core network 206 may manage communication sessions of UEs 102 connecting to core network 206 via access network 204. For example, core network 206 may establish an Internet Protocol (IP) connection between UEs 102 and data networks 208. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven server-less architecture interface, and/or another type of SDN component. The common shared physical infrastructure may be implemented using one or more devices 1000 described below with reference to FIG. 10 in a cloud computing center associated with core network 206. Core network 206 may include 5G core network components, 4G core network components, and/or another type of core network components (e.g., 6G core network components). Some of 5G core network components, which may include part of the system for managing E2IDs, are described below with reference to FIG. 4.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UE 102 and may establish communication sessions with UE 102 via core network 206.

For clarity, FIG. 2 does not show all components that may be included in network environment 200 (e.g., routers, bridges, wireless access point, additional networks, data centers, portals, etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts example components of UE 102 according to an implementation. One of more of these components may be part of a system for managing E2IDs. As shown, UE 102 may include an application (APP) 302, an operating system (OS) 304, a communication system 306, and an eUICC 308. Depending on the implementation, UE 102 may comprise additional components, fewer components, different components, and/or differently arranged components than those illustrated in FIG. 3. For example, in some implementations in which network 104 generates or revokes E2IDs, UE 102 may not include application 302.

Application 302 may include a program that runs on eUICC 308 or on another portion of UE 102. Application 302 may detect installation or removal of a carrier profile on eUICC 308. When application 302 detects a new carrier profile on eUICC 308, application 302 may generate a new E2ID that represents an association between eUICC 308 and the carrier profile. Conversely, when application 302 detects a removal of a carrier profile from eUICC 308, application 302 may initiate a revocation of the E2ID which associates the eUICC and the carrier profile.

To generate a new E2ID or to revoke an E2ID, application 302 may retrieve or obtain a number of parameters. Examples of the parameters include an eUICC ID (EID) and a Vendor Unique Integrated Circuit ID (VUICCID). An EID may identify a particular instance of an eUICC; and a VUICCID may uniquely identify a particular carrier profile. Other examples of the parameters include an Original Equipment Manufacturer (OEM) key associated with eUICC 308, an eUICC Management (EUM) key), and/or an MNO key. Obtaining or retrieving the parameters may include a range of activities, such as accessing eUICC 308 (e.g., to retrieve an EID), receiving parameters as input from the user, or contacting an external entity (e.g., the OEM for eUICC 308, the MNO of network 104, a circuit card management system, etc.). When contacting an external entity, application 302 may establish a secure link with the entity over a broadband link, a WLAN and/or the Internet.

After obtaining the parameters, application 302 may combine the parameters with one another to generate an E2ID. The parameters may be either in plaintext or in an encrypted form. For example, in one embodiment, application 302 may generate an E2ID by concatenating a plaintext EID with a plaintext VUICCID (e.g., X1=E2ID=cat (EID, VUICCID)). In another embodiment, application 302 may generate a preliminary string P1 by concatenating an EID and an OEM key (e.g., P1=cat (EID, OEM key)) and generate a preliminary string P2 by concatenating the VUICCID with the EUM key (e.g., P2=cat (VUICCID, EUM key)). Next, application 302 may generate an E2ID by concatenating P2 to P1 (e.g., X2=E2ID=cat (P1, P2)). Each of the parameters may be in plaintext or encrypted.

In yet another embodiment, application 302 may generate E2ID by concatenating the EID, the VUICCID, and the MNO key (e.g., X3=E2ID=cat (EID, VUICCID, MNO key)). Still, in yet another embodiment, application 302 may generate an E2ID by concatenating X1 with the MNO key (e.g., X4=E2ID=cat (X1, MNO key)). In some embodiments, application 302 may compute an E2ID by XORing one or more of the parameters. For example, application 302 may compute an E2ID by XORing the EID and the VUICCID (e.g., X5=EID XOR VUICCID). In another example, X6=E2ID=P1 XOR P2.

In other implementations, application 302 may generate an E2ID in a manner similar to those described above but using different combinations of Boolean functions, concatenations, pseudo-random encryption keys, etc., to different parameters. Once application 302 generates an E2ID, application 302 may hash or digitally sign the E2ID to secure the E2ID before storing the E2ID or conveying the E2ID to another device (e.g., a device in network 104). For example, application 302 may store a hashed E2ID in eUICC 308 or send the hashed E2ID to network 104.

Operating system 304 may manage applications 302, services, memory, and/or other resources on UE 102. Communication system 306 may perform communication-related functions, including establishing connections between UE 102 and network 104 or another network (e.g., WLAN), delivering messages from/to UE 102 to/from network 104, performing modulation/demodulation, performing signal processing, etc.

When communication system 306 receives a connection request from application 302 via operating system 304, communication system 306 may establish a session with a destination device. For example, communication system 306 may establish a secure connection with network 104, a system at an OEM network, or a circuit card management system and receive the parameters needed to generate E2ID. Furthermore, communication system 306 may relay them to application 302.

eUICC 308 may store carrier profiles 310-1 through 310-T. Each carrier profile 310 may include information that may be used by communication system 306 and/or application 302 to establish connections with provider networks and receive services from the networks. As further shown, each carrier profile 310 may include an authentication key, an International Mobile Subscriber Identity (IMSI), a mobile network code, and a country code. Depending on the implementation, carrier profile 310 may include other information, such as, for example, a Mobile Station International Subscriber Directory Number (MSISDN), a Subscription Permanent Identifier (SUPI), a Subscription Concealed Identifier (SUCI), an International Mobile Equipment Identity (IMEI), etc. Although not shown in FIG. 3, depending on the implementation, eUICC 308 may store information other than carrier profile 310, such as application 302, an eUICC database for storing E2IDs that are generated by application 302, the EID associated with eUICC 308, etc.

FIG. 4 illustrates a portion of a network environment 200. The portion may comprise one or more components of a system for managing E2IDs. As shown, data network 208 may comprise a portal 402 and a circuit card management system 404; and core network 206 may include a Unified Data Management (UDM) 408, a Unified Data Repository (UDR) 410, a Home Subscriber Server (HSS) 412, a provisioning-deprovisioning system (referred to as “provisioning system” or PROV SYS) 414, an E2ID manager 416, and E2ID database (DB) 418. In other implementations, the portion may include additional, fewer, different, or a different arrangement of components than those shown in FIG. 4. For example, in implementations in which UEs 102 include application 302 to generate or revoke E2IDs, the portion may not include E2ID manager 408.

Portal 402 may include a device or a mechanism through which information that triggers provisioning or deprovisioning of carrier profiles 310 may be delivered to provisioning system 414. For example, in one embodiment, portal 402 may include a web site or application server that UE 102 may access to initiate a provisioning process. In another example, portal 402 may include a call center that receives a call from the user to provision UE 102 or deprovision UE 102. Portal 402 may forward to provisioning system 414 information that provisioning system 414 needs to provision or deprovision a carrier profile.

Circuit card management system 404 may include devices for receiving one or more identifiers associated with UE 102 (e.g., an EID), generate a VUICCID, establish an association between the EID and the VUICCID, and provide the VUICCID. After establishing the association, when circuit card management system 404 receives a VUICCID or another ID, circuit card management system 404 may return the corresponding EID. The VUICCID may be used by the requesting entity. In some embodiments circuit card management system 404 may not be implemented in data networks 208 but in networks external to provider network 104.

UDM 408 may maintain subscription data for UEs 102, manage subscriptions, generate authentication credentials, handle user identification, perform access authorization based on subscription data, perform network function registration management, maintain service and/or session continuity by maintaining assignment of a Session Management Function (SMF) for ongoing sessions, support Short Messaging Service SMS) message delivery, support lawful intercept functionality, and/or perform other processes associated with managing user data. UDR 410 may store information that UDM 408 manages. Each subscription profile may include data on UEs 102, such as identifiers (e.g., MSISDN, IMEI, IMSI, etc.). When requested by provisioning system 414 UDM 408 may retrieve UE-related and/or subscriber related data from UDR 410 and provide the data to provisioning system 414. HSS 408 corresponds to an LTE-version of UDM 408/UDR 410 and, for Evolved Packet Core (EPC) components, may play similar roles as UDM 408/UDR 410 for 5G core network components.

Provisioning system 414 may receive a message or information from or via portal 402 for provisioning or deprovisioning UEs 102. When provisioning system 414 receives the message or information, provisioning system 414 may access other components to provision or deprovision UE 102 with a carrier profile 410, conveying information needed to create and to send carrier profile 410 to UE 102. For example, to provision a carrier profile for a new UE 102, provisioning system 414 may relay an EID to circuit card management system 404 to obtain a corresponding VUICCID. In another example, upon receipt of a request to deprovision UE 102, provisioning system 414 may use identifiers associated with UE 102 in the request, to access circuit card management system 404 to obtain additional information needed to deprovision the carrier profile.

Provisioning system 414 may include other components for provisioning or deprovisioning carrier profiles. Provisioning system 408 may include, for example, a Subscription Manager-Data Preparation (SM-DP), a Subscription Manager-Secure Routing (SM-SR), and an Over-the-Air (OTA) server. When provisioning system 414 is activating or deactivating UE 102, provisioning system 414 may 414 may use the SM-DP/SM-SR/OTA server. For example, provisioning system 414 may cause the SM-DP/SM-SR to generate and securely download a carrier profile to UE 102 over the internet. The downloading may be performed over WI-FI before UE 102 can access network 104. In some cases, provisioning system 414 may provide the carrier profile as a Quick Response (QR) code to a destination device or program (e.g., a browser, an email, etc.).

E2ID manager 416 may store and/or retrieve E2IDs in E2ID DB 418. In some implementations, E2ID manager 416 may receive requests from devices to extract an EID, a VUICCID, or other IDs associated with UE 102 from an E2ID. In such instances, E2ID manager 416 may apply reverse processes that are described above for generating E2ID by application 302, to extract an EID or a VUICCID from the E2ID and provide the extracted EID or VUICCID to the requesting component.

In implementations where UE 102 does not include application 302 for generating E2ID, E2ID manager 416 may generate E2IDs in ways similar to those described above for application 302. More specifically, E2ID manager 416 may detect provisioning or deprovisioning of a carrier profile to/from UE 102. When E2ID manager 416 detects the provisioning of the carrier profile, E2ID manager 416 may generate a new E2ID that represents an association between the eUICC 308 of the UE 102 and the profile. Conversely, when E2ID manager 416 detects the deprovisioning of the carrier profile, E2ID manager 416 may initiate a revocation of the E2ID.

To generate a new E2ID or to revoke an E2ID, E2ID manager 416 may retrieve or obtain a number of parameters. Examples of the parameters have been given above with reference to FIG. 3 (e.g., an EID, an OEM key, an EUM key, a VUICCID, an MNO key, etc.). Obtaining or retrieving the parameters may include a range of activities, such as accessing various devices, entities, or components. For example, to generate a new E2ID, E2ID manager 416 may receive an EID from portal 402 or provisioning system 414. In another example, when revoking an E2ID, E2ID manager 416 may obtain the E2ID from portal 402, UE 102, or E2ID DB 418 (e.g., using one of the parameters associated with UE 102 as a key to perform a lookup). In yet another example, E2ID manager 416 may obtain an EID or a VUICC from circuit card management system 404 and use the EID and/or VUICC to obtain the E2ID (e.g., generate the E2ID). When contacting an external entity, E2ID manager 416 may establish a secure link with the entity over a broadband connection, a WLAN, and/or the Internet (e.g., use the VUICC to establish a secure link with circuit card management system 414).

After obtaining the parameters, when generating a new E2ID, E2ID manager 416 may generate an E2ID in the manner described for app 302. After E2ID manager 416 generates an E2ID, E2ID manager 416 may hash or digitally sign the E2ID to secure the E2ID before storing the E2ID or conveying the E2ID to another device (e.g., a device in a network external to provider network 104, UE 102, etc.). For example, E2ID manager 416 may store a hashed E2ID in E2ID DB 418, along with other information (e.g., an EID, a VUICCID, indications that the EID and the VUICCID are bound to one another, etc.).

After obtaining the parameters, when E2ID manager 416 detects deprovisioning of a carrier profile, E2ID manager 416 may revoke the E2ID corresponding to the carrier profile. For example, based on the obtained parameters, E2ID manager 416 may obtain the EID and/or the VUICCID. Next, E2ID manager 416 may look up the corresponding E2ID in E2ID DB 418, or alternatively, regenerate the E2ID based on the parameters as described above. E2ID manager 416 may look up the E2ID in E2ID DB 418 and then indicate, in the record, that the corresponding EID and VUICCID are no longer bound. In some implementations, E2ID manager 416 remove the E2ID entry from E2ID DB 418.

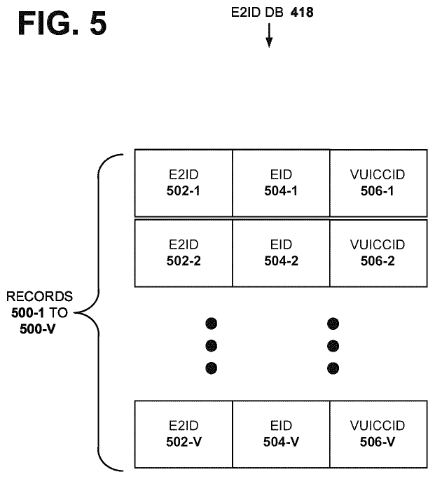

FIG. 5 depicts example components of E2ID DB 418 according to an implementation. As shown, E2ID DB 418 may comprise records 500-1 through 500-V (collectively referred to as records 500). Each record 500 may include an E2ID field 502, an EID field 504, and a VUICCID field 506. Depending on the implementation, each record 500 may include additional or fewer fields than those illustrated in FIG. 5. For example, in a different implementation, record 500 may also include fields for an MSISDN, an IMSI, an IMEI, etc. In yet another implementation, record 500 may not include EID field 504 and/or VUICCID field 506.

E2ID field 502, in some implementations, may store an E2ID that E2ID manager 416 generated. In other implementations in which UEs 102 generate E2IDs, E2ID field 502 may store the E2ID sent by the UE 102 to E2ID manager 416. EID field 504 and VUICCID field 506 may include, respectively, the EID and the VUICCID used by either E2ID manager 416 or applications 302 to generate the E2ID. When E2ID is stored in E2ID field 502 and the corresponding carrier profile has been provisioned, one or more of fields 502-506 may indicate that the E2ID, the EID, and/or the VUICCID stored in fields 502-506 are bound to one another. When the corresponding carrier profile has been deprovisioned, fields 502-506 may indicate that the E2ID, the EID, and/or the VUICCID are idle or unbound. In some implementations, rather than marking the E2ID, the EID, and/or the VUICCID as unbound/idle, E2ID manager 416 may remove the corresponding record 500 from E2ID DB 418.

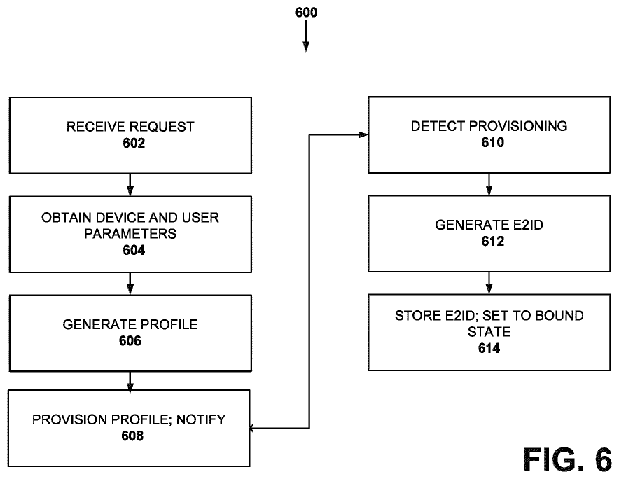

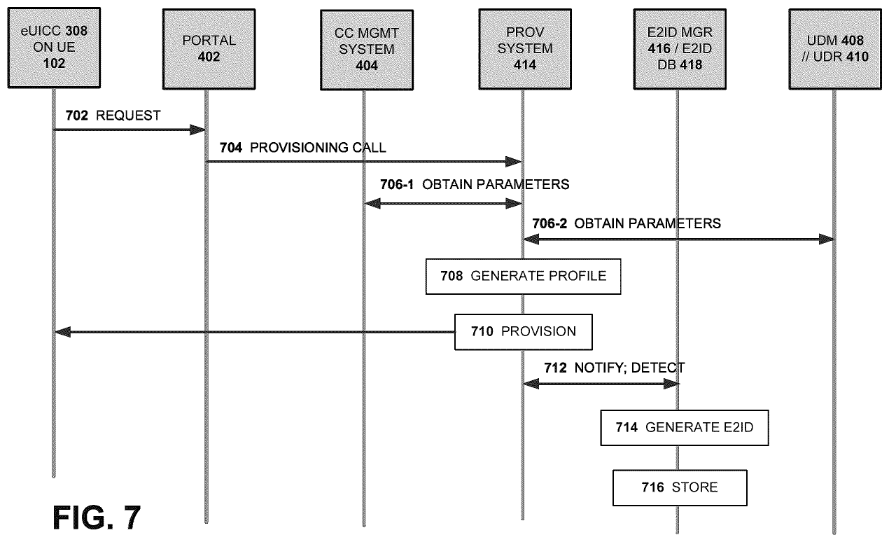

FIG. 6 is a flow diagram of an exemplary process 600 for managing E2IDs in response to provisioning carrier profiles. FIG. 7 is a messaging diagram that is associated with process 600. Process 600 may be performed by various components depicted in FIGS. 1-5. For process 600, assume that the user of UE 102 has just subscribed with provider network 104. As shown in FIG. 6 and exemplified in FIG. 7, process 600 may include receiving a request to provision a carrier profile 310 for UE 102 (block 602). In FIG. 7, provisioning system 414 receives a request to provision a carrier profile from UE 102 via portal 402 (arrows 702 and 704). In the example of FIG. 7, because UE 102 is not yet activated for network 104, the request may be delivered to provisioning system 414 via means other than a direct cellular connection to provider network 104 (e.g., via WI-FI, the Internet, a call center, etc.).

Process 600 may further include obtaining UE device parameters and/or user parameters (block 604). For example, provisioning system 414 may obtain the parameters from circuit card management system 404 and/or UDM 408/UDR 410 (arrows 706-1 and 706-2). As described above with reference to FIG. 3 and FIG. 4, the parameters may include an EID (e.g., received along with the request via portal 402), an IMEI, an MSISDN, an IMSI, a SUPI, etc. Next, provisioning system 414 may generate the carrier profile for UE 102 (block 606; arrow 708) by using one or more of the obtained parameters. After generating the carrier profile (e.g., carrier profile 310), provisioning system 414 may provision the carrier profile 310 to UE 102 (block 608; block 710). Provisioning the carrier profile 310 may entail establishing a communication link with eUICC 308 in UE 102 and storing/installing the carrier profile 310 on eUICC 308, by using one or more of the obtained parameters (e.g., a VUICCID). When the provisioning is complete, provisioning system 414 may notify E2ID manager 416 that UE 102 is provisioned (block 608; arrow 712). The notification may include the EID, the VUICCID, and/or other parameters obtained at block 604.

Process 600 may further include E2ID manager 416 detecting the provisioning of the carrier profile 310 to UE 102 (block 610). Furthermore, in response to detecting the provisioning, E2ID manager 416 may generate an E2ID (block 612; block 714) in the manner described above with reference to FIG. 4. After generating the E2ID, E2ID manager 416 may store the E2ID in E2ID DB 418 (block 614; block 716). E2ID manager 416 may indicate, in E2ID DB 418, that the E2ID, the EID, and/or the VUICCID are bound.

In some implementations, rather than E2ID management system 414, application 302 on UE 102 may detect the provisioning of the carrier profile 310 onto eUICC 308 of UE 102. In such implementations, application 302 may obtain the device/user parameters and use the obtained parameters to generate the E2ID, as described above with reference to FIG. 3. Thereafter, application 302 may send the generated E2ID to E2ID manager 416 for storage.

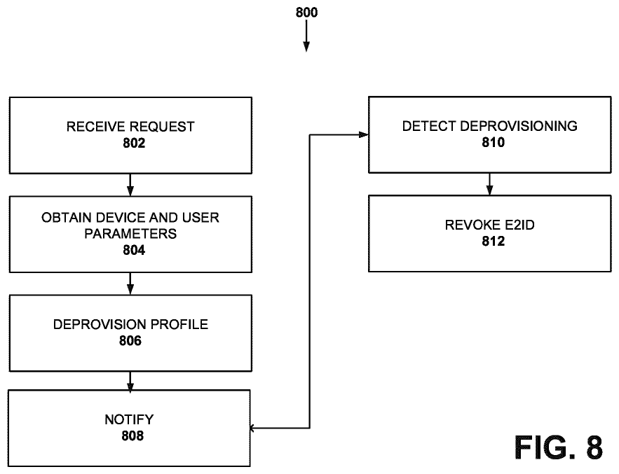

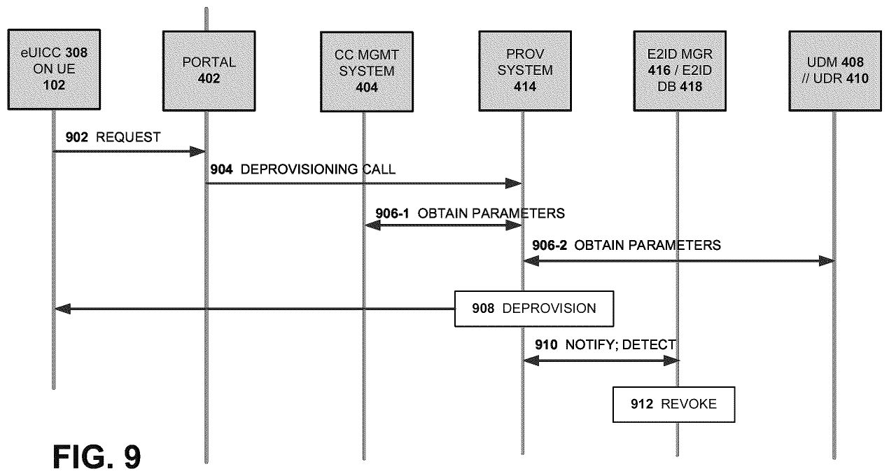

FIG. 8 is a flow diagram of an exemplary process 800 for managing E2IDs in response to deprovisioning carrier profiles. FIG. 9 is a messaging diagram that is associated with process 800. Process 800 may be performed by various components depicted in FIGS. 1-5. For process 800, assume that a user of UE 102 is deactivating UE 102 for a particular account at network 104. As shown in FIG. 8, process 800 may include receiving a request to deprovision a carrier profile 310 for UE 102 (block 802). In FIG. 9, provisioning system 414 receives a request to deprovision a carrier profile from UE 102 via portal 402 (arrows 902 and 904). In the example of FIG. 9, because UE 102 is activated in network 104, the request may be delivered to provisioning system 414 via a cellular connection from UE 102 to network 104, as well as via other means (e.g., via WI-FI and the Internet, via a call center, etc.).

Process 800 may further include obtaining UE device parameters and/or user parameters (block 804). For example, provisioning system 414 may obtain the parameters from circuit card management system 404 and/or UDM 408/UDR 410 (FIG. 9; arrows 906-1 and 906-2). As described above with reference to FIG. 3 and FIG. 4, the parameters may include an EID, an IMEI, an MSISDN, an IMSI, a SUPI, etc. Next, provisioning system 414 may deprovision the carrier profile for UE 102 (block 806; block 908) by using one or more of the obtained parameters. The deprovisioning may include a subscriber management system securely connecting to eUICC 308 on UE 102 and having eUICC 308 delete the carrier profile. After deprovisioning the carrier profile, provisioning system 414 may notify E2ID manager 416 that UE 102 is deprovisioned (block 808; block 910). The notification may include the EID, the VUICCID, and/or other parameters obtained at block 604.

Process 800 may further include E2ID manager 416 detecting the deprovisioning of the carrier profile at UE 102 (block 810; block 910). Furthermore, in response to detecting the deprovisioning of the carrier profile, E2ID manager 416 may revoke the E2ID corresponding to the carrier profile (block 812; block 912). The revocation may include one or more of the following: looking up the E2ID in E2ID DB 418 using one or more of the obtained parameters (e.g., the EID or VUICCID); regenerating E2ID or looking up the E2ID in E2ID DB 418; placing the EID, the VUICCID, and/or the E2ID in idle or unbound state by indicating, in fields 502, 504, and/or 506 of the record corresponding to the E2ID, that the parameters are unbound or idle. In some implementations, E2ID manager 416 may remove the record for the E2ID from E2ID DB 418.

In some implementations, rather than E2ID manager 414 detecting the deprovisioning, application 302 on UE 102 may detect the deprovisioning of the carrier profile 310 at eUICC 308 of UE 102 and revoke the corresponding E2ID. In such implementations, application 302 may obtain the device/user parameters (e.g., from within eUICC 308 or from a remote device) and use the obtained parameters to revoke the E2ID. The revocation may include, for example, deleting any local copy of the E2ID and/or notifying E2ID manager 414 of the revocation. In response, E2ID manager 414 may modify E2ID DB 418, either removing the record corresponding to the E2ID or placing the EID, the VUIUCCID, and/or the E2ID in the unbound or idle state.

FIG. 10 depicts exemplary components of an exemplary network device 1000. Network device 1000 may correspond to or be included in any of the devices and/or components illustrated in FIGS. 1-4, 7, and 9 (e.g., UE 102, core network 206, data network 208, access station 210, portal 402, circuit card management system 404, UDM 408, UDR 410, HSS 412, provisioning system 414, E2ID manager 416, E2ID DB 418, etc.). In some implementations, network devices 1000 may be part of a hardware network layer on top of which other network layers and network functions (NFs) may be implemented.

As shown, network device 1000 may include a processor 1002, memory/storage 1004, input component 1006, output component 1008, network interface 1010, and communication path 1012. In different implementations, network device 1000 may include additional, fewer, different, or different arrangement of components than the ones illustrated in FIG. 10. For example, network device 1000 may include line cards, switch fabrics, modems, etc.

Processor 1002 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 1000 and/or executing programs/instructions.

Memory/storage 1004 may include static memory, such as read only memory (ROM), and/or dynamic memory, such as random access memory (RAM), or onboard cache, for storing data and machine-readable instructions (e.g., programs, scripts, etc.). Memory/storage 1004 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 1004 may be external to and/or removable from network device 1000. Memory/storage 1004 may include, for example, a Universal Serial Bus (USB) memory stick, a dongle, a hard disk, off-line storage, a Blu-Ray® disk (BD), etc. Memory/storage 1004 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 1006 and output component 1008 may provide input and output from/to a user to/from network device 1000. Input/output components 1006 and 1008 may include a display screen, a keyboard, a mouse, a speaker, a microphone, a camera, a DVD reader, USB lines, and/or other types of components for obtaining, from physical events or phenomena, to and/or from signals that pertain to network device 1000.

Network interface 1010 may include a transceiver (e.g., a transmitter and a receiver) for network device 1000 to communicate with other devices and/or systems. For example, via network interface 1010, network device 1000 may communicate over a network, such as the Internet, an intranet, cellular, a terrestrial wireless network (e.g., a WLAN, WIFI, WIMAX, etc.), a satellite-based network, optical network, etc. Network interface 1010 may include a modem, an Ethernet interface to a LAN, and/or an interface/connection for connecting network device 1000 to other devices (e.g., a Bluetooth interface).

Communication path or bus 1012 may provide an interface through which components of network device 1000 can communicate with one another.

Network device 1000 may perform the operations described herein in response to processor 1002 executing software instructions stored in a non-transient computer-readable medium, such as memory/storage 1004. The software instructions may be read into memory/storage 1004 from another computer-readable medium or from another device via network interface 1010. The software instructions stored in memory/storage 1004, when executed by processor 1002, may cause processor 1002 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 6-9, the order of the actions, messages, signals may be modified in other implementations. In addition, non-dependent actions, messages, and signals may represent actions, messages, and signals that can be performed, sent, and/or received in parallel and in different order. Furthermore, each of actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code-it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A device comprising:
a processor configured to:
detect either provisioning or deprovisioning a User Equipment device (UE) with a carrier profile;
obtain a first identifier that identifies the UE and a second identifier that identifies the carrier profile;
generate a third identifier based on the first identifier and the second identifier, wherein the third identifier associates the first identifier and the second identifier; and
perform one of:
store the third identifier via a network device included in the network; or
revoke the third identifier.

2. The device of claim 1, wherein the first identifier includes an embedded Universal Integrated Circuit Card Identifier (EID) that identifies an embedded Universal Integrated Circuit Card (eUICC); and the second identifier includes a Vendor Unique Integrated Circuit Card Identifier (VUICCID) that identifies the carrier profile.

3. The device of claim 1, wherein the device is the UE, wherein when the processor stores the third identifier, the processor is configured to:
transmit the third identifier to the network device.

4. The device of claim 1, wherein the device includes a core network device included in the network, wherein the device is configured to:
receive, from another device in the network, an indication that the UE is provisioned.

5. The device of claim 1, wherein when the processor obtains the first identifier and the second identifier, the processor is configured to:
receive, from a system included in the network, one or more parameters that identify the UE or a subscriber associated with the UE.

6. The device of claim 5, wherein when the processor generates the third identifier, the processor is configured to:
encrypt one or both of the first identifier and the second identifier; and
concatenate one or more of the parameters with the first identifier or the second identifier to generate the third identifier.

7. The device of claim 1, wherein when the processor stores the third identifier, the processor indicates, in a record that includes the third identifier, that the first identifier and the second identifier are bound to one another.

8. The device of claim 1, wherein when the processor revokes the third identifier, the processor is configured to:
modify a record that includes the third identifier to indicate that the first identifier and the second identifier are not bound and are in an idle state; or
delete the record.

9. A method comprising:
detecting either provisioning or deprovisioning a User Equipment device (UE) with a carrier profile;
obtaining a first identifier that identifies the UE and a second identifier that identifies the carrier profile;
generating a third identifier based on the first identifier and the second identifier, wherein the third identifier associates the first identifier and the second identifier; and
performing one of:
storing the third identifier via a network device included in the network; or
revoking the third identifier.

10. The method of claim 9, wherein the first identifier includes an embedded Universal Integrated Circuit Card Identifier (EID) that identifies an embedded Universal Integrated Circuit Card (eUICC); and the second identifier includes a Vendor Unique Integrated Circuit Card Identifier (VUICCID) that identifies the carrier profile.

11. The method of claim 9, wherein storing the third identifier includes transmitting the third identifier from the UE to the network device.

12. The method of claim 9, further comprising:
receiving, from the UE, an indication that the UE is provisioned.

13. The method of claim 9, wherein obtaining the first identifier and the second identifier includes:
receiving, from a system included in the network, one or more parameters that identify the UE or a subscriber associated with the UE.

14. The method of claim 13, wherein generating the third identifier includes:
encrypting one or both of the first identifier and the second identifier, and
concatenating one or more of the parameters with the first identifier or the second identifier to generate the third identifier.

15. The method of claim 9, wherein storing the third identifier includes:
indicating, in a record that includes the third identifier, that the first identifier and the second identifier are bound to one another.

16. The method of claim 9, wherein revoking the third identifier includes:
modifying a record that includes the third identifier, to indicate that the first identifier and the second identifier are not bound and are in an idle state; or
deleting the record.

17. The method of claim 9, further comprising:
provisioning or deprovisioning the UE with the carrier profile.

18. The method of claim 17, wherein the provisioning includes:
generating the carrier profile; and
installing the carrier profile on the UE via the Internet.

19. The method of claim 18, wherein the provisioning further comprises:
receiving the first identifier from the UE;
transmitting the first identifier to a circuit card management system that is external to the network;
receiving the second identifier from the circuit card management system; and
using the second identifier to establish a secure connection with a component in the UE; and
have the component install the carrier profile on the component.

20. A non-transitory computer-readable medium comprising processor-executable instructions, which when executed by a processor included in a device, cause the processor to:
detect either provisioning or deprovisioning a User Equipment device (UE) with a carrier profile;
obtain a first identifier that identifies the UE and a second identifier that identifies the carrier profile;
generate a third identifier based on the first identifier and the second identifier, wherein the third identifier associates the first identifier and the second identifier; and
perform one of:
store the third identifier via a network device included in the network; or
revoke the third identifier.
